(19) United States
(12) Patent Application Publication
(10) Pub. No.: US 2023/0071872 A1
(43) Pub. Date: Mar. 9, 2023

(54) COIL COMPONENT

(71) Applicant: SAMSUNG ELECTRO-MECHANICS CO., LTD., Suwon-si (KR)

(72) Inventor: Sung Kwon Oh, Suwon-si (KR)

(73) Assignee: SAMSUNG ELECTRO-MECHANICS CO., LTD., Suwon-si (KR)

(21) Appl. No.: 17/883,765

(22) Filed: Aug. 9, 2022

(30) Foreign Application Priority Data
Sep. 7, 2021 (KR) 10-2021-0119003

(51) Int. Cl. H01F 27/28

(52) U.S. Cl. CPC H01F 27/2847; H01F 2027/2857

(57) ABSTRACT

A coil component includes: a body including one surface and one side surface and the other side surface respectively connected to the one surface and opposing each other; a coil portion disposed within the body; a marker disposed on the one surface of the body; and a coating layer disposed on the one surface of the body to cover the marker, wherein the coating layer includes a light-transmitting resin.

### CROSS-REFERENCE TO RELATED APPLICATION(S)

This application claims the benefit of priority to Korean Patent Application No. 10-2021-0119003 filed on Sep. 7, 2021 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in an electronic device together with a resistor and a capacitor.

As the electronic device implements high-performance and has a smaller size, the electronic components used in the electronic device may have increased numbers and a smaller size.

A magnetic flux may be generated when current flows due to an inner coil of an L-shaped or bottom electrode type component. This magnetic flux may affect a surrounding component, and may thus be required to be managed to have a predetermined direction. The inner coil may thus be disposed in the predetermined direction by forming a mark on an upper end of the coil component, and mounted on a board in a direction of the mark. Here, the mark may be disposed on an uppermost end of the component, and may thus be vulnerable to physical impacts, which may cause the mark to be blurred. Accordingly, research has been undertaken to solve this problem.

### SUMMARY

An aspect of the present disclosure may provide a coil component which may be mounted on a board including a microcircuit pattern.

Another aspect of the present disclosure may provide a coil component which may prevent damage to a mark.

According to an aspect of the present disclosure, a coil component includes a body including one surface and one side surface and the other side surface respectively connected to the one surface and opposing each other, a coil portion disposed within the body, a marker disposed on the one surface of the body, and a coating layer disposed on the one surface of the body to cover the marker, wherein the coating layer includes a light-transmitting resin.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a view schematically illustrating an example of coil component according to the present disclosure;

FIGS. 2A and 2B are views respectively illustrating a cross section taken along lines I-I′ and II-II′ of FIG. 1;

FIG. 3 is a view schematically illustrating a further example of a coil component according to the present disclosure;

FIG. 4 is a view schematically illustrating another example of a coil component according to the present disclosure;

FIG. 5 is a view schematically illustrating a still further example of a coil component according to the present disclosure;

FIGS. 6A through 6E are views schematically illustrating a manufacturing method of a coil component according to the present disclosure; and

FIGS. 7A and 7B are views schematically illustrating the manufacturing method of a coil component according to the present disclosure.

### DETAILED DESCRIPTION

Hereinafter, exemplary embodiments in the present disclosure will now be described in detail with reference to the accompanying drawings. The shape and size of constituent elements in the drawings may be exaggerated or reduced for clarity. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

In describing exemplary embodiments of the present disclosure with reference to the accompanying drawings, components that are the same as or correspond to each other will be denoted by the same reference numerals, and overlapping descriptions thereof will be omitted.

The contents of the present disclosure described below may have a variety of configurations and propose only a required configuration herein, but are not limited thereto.

In the drawings, a T direction refers to a first direction or a thickness direction, a W direction refers to a second direction or a width direction, and an L direction refers to a third direction or a length direction.

Hereinafter, a coil component according to exemplary embodiments of the present disclosure will be described in detail with reference to the accompanying drawings.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter or the like.

### Coil Component

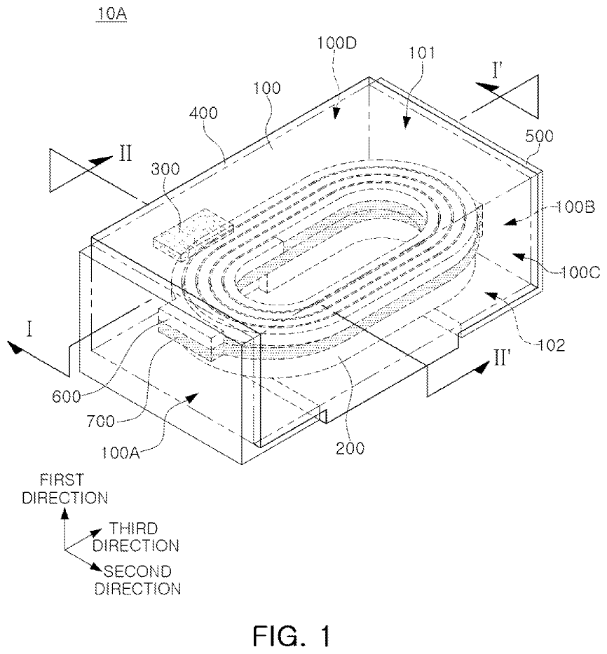

FIG. 1 is a view schematically illustrating a coil component according to the present disclosure.

Referring to the drawing, a coil component 10A according to an exemplary embodiment of the present disclosure may include a body 100 including one surface 101 and one side surface and the other side surface 100A and 100B respectively connected to the one surface and opposing each other in the second direction, a coil portion 200 disposed within the body 100, a marker 300 disposed on the one surface 101 of the body 100, and a coating layer 400 disposed on the one surface 101 of the body to cover the marker 300.

Here, the marker 300 may protrude from the body 100, and one surface 301 of the marker and both side surfaces 300A and 300B connected to the one surface 301, may each have at least a portion in contact with the coating layer 400, and is not limited thereto.

Here, the coating layer 400 may include a light-transmitting resin, and have a light transmittance of 85% or more and 95% or less with respect to a visible light wavelength. In addition, the coating layer 400 may have the light transmittance which may be visually identified from the visible light wavelength, and is not limited thereto. In particular, the light transmittance of the coating layer 400 with respect to the visible light wavelength in a range in which the marker 300 embedded in the coating layer 400 may be visually identified may have any numerical value.

The coating layer 400 may include at least one of thermosetting resins such as epoxy-based, silica-based and acrylic-based resins, and is not limited thereto.

When the coating layer 400 has a light transmittance of less than 85% with respect to the visible light wavelength, it may be difficult to visually identify the marker 300 embedded in the coating layer 400, the coating layer 400 may thus have the light transmittance of 85% or more with respect to the visible light wavelength, and is not limited thereto.

In addition, when the coating layer 400 has a light transmittance of more than 95% with respect to the visible light wavelength, manufacturing costs may be excessively increased. Therefore, the coating layer 400 may have the light transmittance of 85% or more and 95% or less with respect to the visible light wavelength.

The partial or entire coating layer 400 surrounding the body 100 may be extracted to measure the light transmittance of the coating layer 400. A method of measuring the light transmittance of the coating layer 400 may be the same as a known method, and is not limited thereto.

Here, the light transmittance of the coating layer 400 may be measured by selecting any point of the coating layer 400. In more detail, any point of the coating layer 400 may be selected, the light transmittance of the corresponding point may then be measured several times, and an average value of the measurements may correspond to the light transmittance of the coating layer 400. Alternatively, a plurality of any points of the coating layer 400 may be selected, and an average value of light transmittance measured at the plurality of any points may correspond to the light transmittance of the coating layer 400. Here, the average value may correspond to an arithmetic average value, and is not limited thereto.

In this manner, it may be easy to read the mark by using the resin having a high light transmittance for the coating layer 400, and the coil component may thus be measured by using a current equipment specification as it is, or aligned or the like in a taping process by using the same. In addition, the coating layer 400 may have an increased degree of freedom in selecting a thickness thereof by making a material of the coating layer 400 transparent or translucent, and is not limited thereto.

In addition, the coating layer 400 may cover each of the one surface 301 and both side surfaces 300A and 300B of the marker 300 to prevent the marker 300 from being damaged from an external physical impact.

In addition, the coil component 10A according to this exemplary embodiment may include a lead-out portion 600 disposed within the body 100, connected to the coil portion 200, and have at least a portion exposed to each of the one side surface and the other side surface 100A and 100B of the body.

In addition, the body 100 of the coil component 10A according to this exemplary embodiment may include the one surface 101 of the body, the other surface 102 opposing the one surface of the body in the first direction, and first to fourth side surfaces 100A, 100B, 100C and 100D respectively connected to the one surface and the other surface. Here, each of the one side surface and the other side surface of the body, opposing each other in the third direction may correspond to the first and second side surfaces 100A and 100B of the body.

The first and second side surfaces 100A and 100B of the body 100 may oppose each other in the third direction, and the third and fourth side surfaces 100C and 100D may oppose each other in the second direction.

In addition, the coil portion 200 may include a coil pattern 210 having at least one turn and an insulating layer 220 covering the coil pattern 210. Here, the insulating layer 220 may function to insulate the body 100 and the coil pattern 210 from each other, and is not limited thereto.

In addition, the coil component 10A according to this exemplary embodiment may further include a board 700 disposed within the body 100 and having one surface on which the coil portion 200 is disposed. The board 700 may support the coil portion 200, and is not limited thereto. Here, the insulating layer 220 of the coil portion may be extended to cover the board 700.

Here, the coil component may include the coil portions 200 respectively disposed on upper and lower portions of the board 700, and a via passing through the board 700 to connect the coil portions 200 respectively disposed on the upper and lower portions thereof, and is not limited thereto.

In addition, the board 700 may have at least a portion exposed to each of the one side surface and the other side surface 100A and 100B of the body, and is not limited thereto.

In addition, the coil component 10A according to this exemplary embodiment may further include an external electrode 500 disposed on at least a portion of each of the one side surface and the other side surface 100A and 100B of the body 100, opposing each other in the third direction. In addition, the external electrode 500 may have at least a portion further extended to the other surface 102 of the body. Here, the external electrode 500 disposed on at least a portion of each of the one side surface and the other side surface 100A and 100B of the body 100 may have at least a portion in contact with the lead-out portion 600. In addition, when the board 700 supporting the coil portion 200 is disposed, the external electrode 500 may be in more contact with at least a portion of the board 700 exposed to at least a portion of each of the one side surface and the other side surface 100A and 100B of the body.

In addition, in the coil component 10A according to this exemplary embodiment, the coating layer 400 may be extended to each of the one surface 101, the other surface 102 of the body 100, opposing the one surface in the first direction and the first to fourth side surfaces 100A, 100B, 100C and 100D, and the coating layer 400 may be formed only on a region of the other surface 102 of the body, where the external electrode 500 is not disposed.

The body 100 may form an appearance of the coil component 10A according to this exemplary embodiment, and may embed the coil portion 200 therein. The body 100 may generally have a hexahedral shape.

The body 100 may include a magnetic material and an insulating resin. In detail, the body 100 may be formed by stacking at least one magnetic composite sheet including the insulating resin and the magnetic materials dispersed in the insulating resin. However, the body 100 may have a structure other than a structure in which the magnetic materials are dispersed in the insulating resin. For example, the body 100 may be made of the magnetic material such as ferrite.

The magnetic material may be ferrite or metal magnetic powder particles.

The ferrite powder particles may include, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite; a hexagonal type ferrite such as Ba—Zn-based ferrite, Ba—Mg-based ferrite, Ba—Ni-based ferrite, Ba—Co-based ferrite or Ba—Ni—Co-based ferrite; and a garnet type ferrite such as Y-based ferrite or Li-based ferrite.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powder particles may be one or more of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles and Fe—Cr—Al-based alloy powder particles.

The metal magnetic powder particles may be amorphous or crystalline. For example, the metal magnetic powder particles may be Fe—Si—B—Cr based amorphous alloy powder particles, and are not necessarily limited thereto.

The ferrite and the metal magnetic powder particles may have average diameters of about 0.1 μm to 30 μm, respectively, and are not limited thereto.

The body 100 may include two or more types of magnetic materials dispersed in the resin. Here, different types of magnetic materials may indicate that the magnetic materials dispersed in the insulating resin are distinguished from each other by any one of an average diameter, a composition, crystallinity and a shape.

The insulating resin may include epoxy, polyimide, liquid crystal polymer (LCP) or the like, or a mixture thereof, and is not limited thereto.

The coil portion 200 may be embedded in the body 100. The coil portion 200 may exhibit a characteristic of the coil component according to the present disclosure. For example, when the coil component of this exemplary embodiment is used as the power inductor, the coil portion 200 may serve to store energy as a magnetic field to maintain an output voltage, thereby stabilizing power of the electronic device. Here, the coil portion 200 may not be limited to a thin-film coil, and may be a wound-type coil or a stacked-type coil.

The coil portion 200, the lead-out portion 600 and the via may each be formed of a conductive material such as copper (Cu), aluminum (Al), silver (Ag), tin (Sn), gold (Au), nickel (Ni), lead (Pb), titanium (Ti) or an alloy thereof, and is not limited thereto.

The marker 300 may be in contact with the one surface 101 of the body, and covered by the coating layer 400. Here, the marker 300 may include a material having a lower light transmittance than the coating layer 400, and may thus be visually identified in a structure covered by the coating layer 400. The marker 300 may indicate at least any one of the directionality, product name or manufacturing number of the coil component 10 according to the present disclosure, and is not limited thereto.

The marker 300 may include an insulating material. For example, the marker 300 may include at least one of an epoxy and a silica-based resin, and is not limited thereto.

In addition, the marker 300 may be formed by printing or dipping, and is not limited thereto.

The board 700 may be formed of an insulating material including a thermosetting insulating resin such as an epoxy resin, a thermoplastic insulating resin such as polyimide or a photosensitive insulating resin, or an insulating material impregnated with a reinforcing material such as glass fiber or inorganic filler in the insulating resin. For example, the board 700 may be formed of an insulating material such as a copper clad laminate (CCL), an unclad CCL, prepreg, an Ajinomoto build-up film (ABF), FR-4, a bismaleimide triazine (BT) film or a photo imageable dielectric (PID), and is not limited thereto.

The inorganic filler may use one or more materials selected from the group consisting of silica (SiO₂), alumina (Al₂O₃), silicon carbide (SiC), barium sulfate (BaSO₄), talc, clay, mica powder particles, aluminum hydroxide (AlOH₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃).

When formed of the insulating material including the reinforcing material, the board 700 may provide higher rigidity. The board 700 may be formed of the insulating material not including the glass fiber, which may be advantageous because the coil portion 200 may have an increased volume in the body 100 having the same size.

When the board 700 is formed of the insulating material including the photosensitive insulating resin, it is possible to reduce the number of processes of forming the coil portion 200, which may be advantageous in reducing a production cost and forming a fine via.

A metal included in the external electrode 500 may be an alloy of two or more selected from the group consisting of tin (Sn), lead (Pb), indium (In), copper (Cu), silver (Ag) and bismuth (Bi).

The external electrode 500 may be formed by applying a conductive resin paste or may be formed by plating a material including the metal material, and is not limited thereto.

The insulating layer 220 of the coil portion 200 may be formed by using at least one of a vapor deposition method and a film lamination method. Meanwhile, the insulating layer 220 formed by using the latter method may be a permanent resist in which a plating resist used in plating the coil portion 200 on the board 700 remains in a final product, and is not limited thereto.

In addition, the external electrode 500 may further include a plating layer. Here, the plating layer may include the conductive material. The plating layer may be electrically connected to a solder, which is a connecting conductor. Here, the plating layer may include nickel (Ni) or tin (Sn), and may have a structure in which a nickel (Ni) plating layer and a tin (Sn) plating layer are sequentially stacked. When the external electrode is a conductive resin layer, the nickel (Ni) plating layer may be in contact with the conductive connection portion and base resin of the conductive resin layer in the external electrode 500.

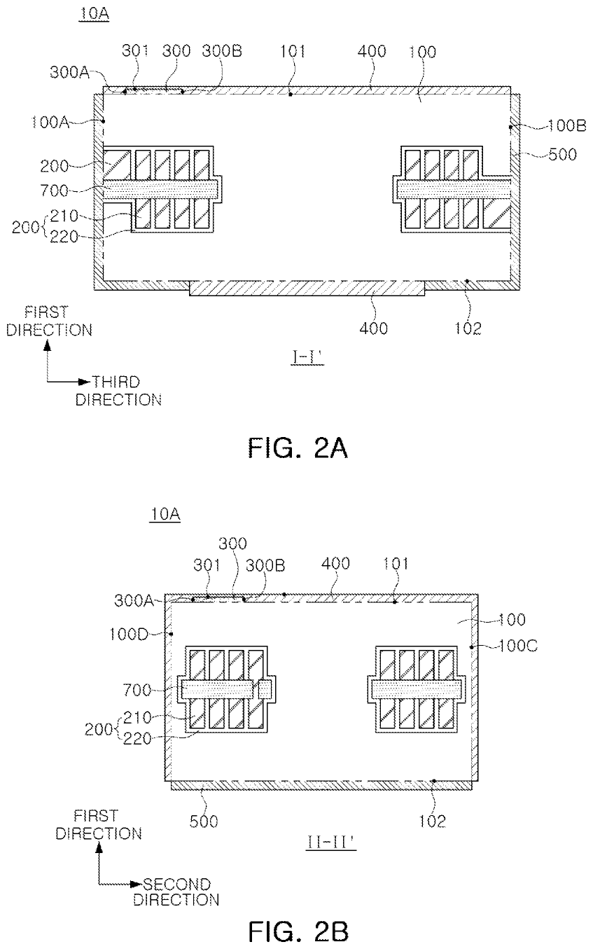

FIGS. 2A and 2B are views respectively illustrating a cross section taken along lines I-I′ and II-II′ of FIG. 1.

Lines I-I′ and II-II′ of FIG. 1 may indicate lines cut to pass through the marker 300 of the coil component 10A according to the present disclosure.

Referring to the drawing, the body 100 of the coil component 10A according to this exemplary embodiment may have the one surface 101 and the other surface 102, opposing each other in the first direction, and the marker 300 and the coating layer 400 covering the marker 300 may be disposed on the one surface 101 of the body. Here, the coating layer 400 may cover each of the one surface 301 and both side surfaces 300A and 300B of the marker 300, and although not shown, may be spaced apart from the one surface 301 of the marker 300. That is, the marker 300 may be embedded in the coating layer 400 or may protrude therefrom, and is not limited thereto.

In addition, the coating layer 400 of the coil component 10A according to this exemplary embodiment may entirely cover the one surface 101 of the body, and have at least a portion extended to each of the one side surface and the other side surface 100A and 100B of the body.

Here, the external electrode 500 disposed on each of the one side surface and the other side surface 100A and 100B of the body may be in contact with the coating layer 400 having at least a portion extended to each of the one side surface and the other side surface 100A and 100B of the body. On the other hand, when not extended to each of the one side surface and the other side surface 100A and 100B of the body, the coating layer 400 may be spaced apart from the external electrode 500, and is not limited thereto.

The coating layer 400 of the coil component 10A according to this exemplary embodiment may be extended to the third and fourth side surfaces 100C and 100D of the body, and may here also be extended to the other surface 102 opposing the one surface of the body. That is, the coating layer 400 may entirely cover the portion of the coil component except for a region where the external electrode 500 is formed, have at least a portion in contact with the external electrode 500, spaced apart from the external electrode 500, and is not limited thereto.

In addition, referring to the drawing, the coil component 10A according to this exemplary embodiment may include the coil portions 200 respectively disposed on the upper and lower portions of the board 700, and the via passing through the board 700 to connect the coil portions 200 disposed on the upper and lower portions thereof, and is not limited thereto.

The coil portion 200 may include the coil pattern 210 having at least one turn and the insulating layer 220 covering the coil pattern. Here, the insulating layer 220 may function to insulate the body 100 and the coil portion 200 from each other, and is not limited thereto.

Descriptions of the other components are substantially the same as those described above, and detailed descriptions thereof are thus omitted.

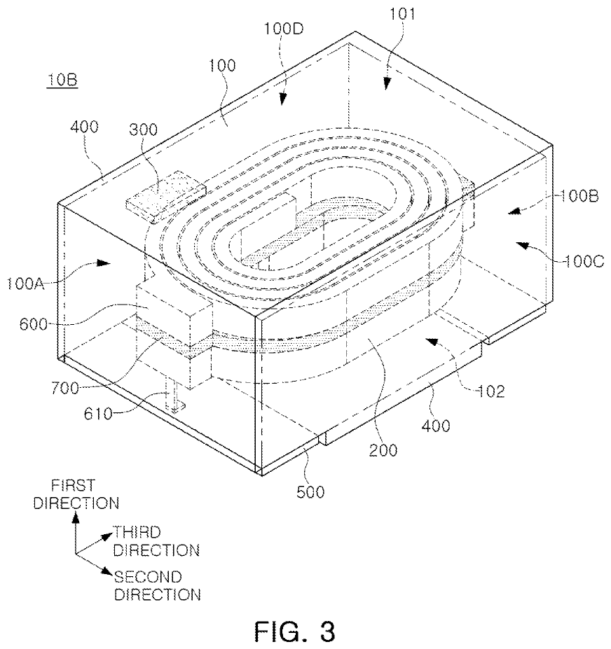

FIG. 3 is a view schematically illustrating a further coil component according to the present disclosure.

Referring to the drawing, a coil component 10B according to another exemplary embodiment may include the lead-out portion 600 connected to the coil portion 200 and exposed to at least a portion of each of the one side surface and the other side surface 100A and 100B of the body, and the external electrodes 500 respectively disposed on the other surface 102 opposing the one surface 101 of the body 100, while being spaced apart from each other. Here, the external electrode 500 may not be extended to the one side surface and the other side surface 100A and 100B of the body.

Here, the lead-out portion 600 may include a connection portion 610 connecting each of the external electrodes 500 respectively disposed only on the one surface 101 of the body, while being spaced apart from each other, and the lead-out portion 600 to each other. However, although not shown, the lead-out portion 600 may be in direct contact with the external electrode 500 without the separate connection portion 610, and is not limited thereto.

The coating layer 400 of the coil component 10B according to this exemplary embodiment may cover at least a portion of each of the one surface 101 of the body 100, the other surface 102 and the first to fourth side surfaces 100A, 100B, 100C and 100D respectively connected to the one surface and the other surfaces 101 and 102, and is not limited thereto.

Here, the coating layer 400 may be in contact with at least a portion of the external electrode 500 disposed only on the other surface 102 of the body, or spaced apart from the external electrode 500. In addition, the coating layer 400 may be disposed only in the rest of the other surface 102 of the body, except for the regions where the external electrodes 500 are disposed while being spaced apart from each other, and is not limited thereto.

Descriptions of the other components are substantially the same as those described above, and detailed descriptions thereof are thus omitted.

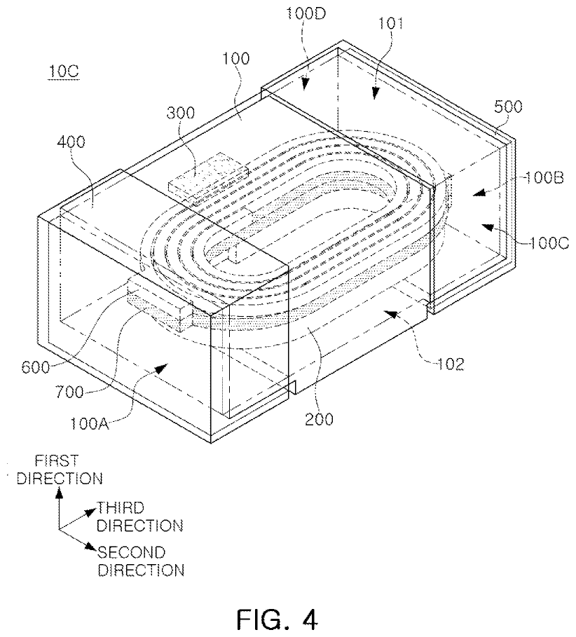

FIG. 4 is a view schematically illustrating yet a further coil component according to the present disclosure.

Referring to the drawing, a coil component 10C according to yet another exemplary embodiment of the present disclosure may include the lead-out portion 600 connected to the coil portion 200 and exposed to at least a portion of each of the one side surface and the other side surface 100A and 100B of the body, and the external electrode 500 disposed on at least a portion of each of the one and the other surfaces 100A and 100B of the body and connected to the lead-out portion 600.

The external electrode 500 may be extended to at least a portion of each of the one surface 101 of the body and the other surface 102 opposing the one surface. Here, the external electrodes 500 may also be extended to the third and fourth side surfaces 100C and 100D of the body, and disposed on five surfaces of the body, while being spaced apart from each other.

Descriptions of the other components are substantially the same as those described above, and detailed descriptions thereof are thus omitted.

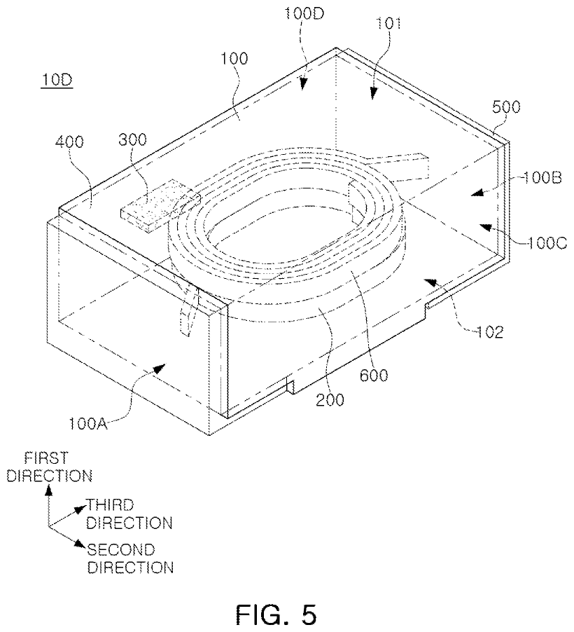

FIG. 5 is a view schematically illustrating still a further coil component according to the present disclosure.

Referring to the drawing, a coil component 10D according to still another exemplary embodiment of the present disclosure may include the body 100 including the first to fourth side surfaces 100A, 100B, 100C and 100D, and the one surface 101 and the other surface 102, connected to each of the first to fourth side surfaces and opposing each other in the first direction, the coil portion 200 disposed within the body 100, the marker 300 disposed on the one surface 101 of the body 100, the coating layer 400 disposed on the one surface 101 of the body to cover the marker 300, and the lead-out portion 600 disposed within the body 100 and connected to the coil portion 200 to be exposed to at least a portion of each of the first and second side surfaces 100A and 100B of the body.

Here, the first and second side surfaces 100A and 100B of the body 100 may oppose each other in the third direction, and the third and fourth side surfaces 100C and 100D may oppose each other in the second direction.

Here, the coil portion 200 may include a wound-type coil pattern covered by an insulating film, and the insulating film may here function to insulate the body 100 and the coil portion 200 from each other, and is not limited thereto.

The marker 300 may protrude from the body 100, and each of the one surface 301 of the marker and both the side surfaces 300A and 300B of the marker, connected to the one surface 301, may be in contact with at least a portion of the coating layer 400, and is not limited thereto.

Here, the coating layer 400 may include the light-transmitting resin, and may have the light transmittance of 85% or more and 95% or less with respect to the visible light wavelength. In addition, the coating layer 400 may have the light transmittance which may be visually identified from the visible light wavelength, and is not limited thereto. In more detail, the coating layer 400 may include the epoxy-based or silica-based resin, and is not limited thereto.

In particular, when the coating layer 400 has the light transmittance of less than 85% with respect to the visible light wavelength, it may be difficult to visually identify the marker 300 embedded in the coating layer 400, and when the coating layer 400 includes a material having the light transmittance of more than 95%, manufacturing costs may be excessively increased. Therefore, the coating layer 400 may have the light transmittance of 85% or more and 95% or less with respect to the visible light wavelength.

In this manner, it may be easy to read the mark by using the resin having the high light transmittance for the coating layer 400, and the coil component may thus be measured by using the current equipment specification as it is, or aligned or the like in the taping process by using the same. In addition, the coating layer 400 may have the increased degree of freedom in selecting its thickness by making the material of the coating layer 400 transparent or translucent, and is not limited thereto.

In addition, the coating layer 400 may cover each of the one surface 301 and both the side surfaces 300A and 300B of the marker 300 to prevent the marker 300 from being damaged from the external physical impact.

In addition, in the coil component 10D according to this exemplary embodiment, the coil portion 200 may be embedded in the body 100 without a separate board, and spaced apart from each of the first to fourth side surfaces 100A, 100B, 100C and 100D, the one surface 101 and the other surface 102 of the body, and is not limited thereto.

In addition, although not shown, the body 100 of the coil component according to this exemplary embodiment may include a mold portion having one surface on which the coil portion 200 is disposed. Here, the body 100 may include a cover portion disposed over the coil portion 200 and the mold portion, and is not limited thereto.

In addition, although not shown, in the coil component 10D according to this exemplary embodiment, the insulating film may be additionally disposed on each of the first to fourth side surfaces 100A, 100B, 100C and 100D of the body 100, and is not limited thereto.

In addition, the coil component 10D according to this exemplary embodiment may further include the external electrode 500 disposed on at least a portion of each of the one side surface and the other side surface 100A and 100B of the body 100, opposing each other in the third direction. In addition, at least a portion of the external electrode 500 may be further extended to the other surface 102 opposing the one surface 101 of the body. Here, the external electrode 500 disposed on at least a portion of each of the one side surface and the other side surface 100A and 100B of the body 100 may be in contact with at least a portion of the lead-out portion 600.

In addition, the external electrodes 500 may also be extended to, at least a portion of each of the one surface 101 of the body and the other surface 102 opposing the one surface, and the third and fourth side surfaces 100C and 100D of the body, and disposed on the five surfaces of the body, while being spaced apart from each other.

In addition, although not shown, the external electrodes 500 may be disposed only on the one surface 101 of the body, while being spaced apart from each other, and may not be extended to the one side surface and the other side surface 100A and 100B of the body. Here, the lead-out portion 600 may include the connection portion 610 connecting each of the external electrodes 500 respectively disposed only on the one surface 101 of the body, while being spaced apart from each other, and the lead-out portion 600 to each other. However, the lead-out portion 600 may be in direct contact with the external electrode 500 without the separate connection portion 610, and is not limited thereto.

In addition, the coating layer 400 of the coil component 10D according to this exemplary embodiment may entirely cover the one surface 101 of the body, and have at least a portion extended to each of the one side surface and the other side surface 100A and 100B of the body.

When disposed on each of the one side surface and the other side surface 100A and 100B of the body, the external electrode 500 may be in contact with the coating layer 400 having at least a portion extended to each of the one side surface and the other side surface 100A and 100B of the body. On the other hand, when not extended to each of the one side surface and the other side surface 100A and 100B of the body, the coating layer 400 may be spaced apart from the external electrode 500, and is not limited thereto.

When the external electrode 500 is not disposed on each of the one side surface and the other side surface 100A and 100B of the body, the coating layer 400 may cover each of the one side surface and the other side surface 100A and 100B of the body. In addition, the coating layer 400 may be spaced apart from the external electrode 500, having at least a portion in contact with the external electrode 500, and is not limited thereto.

The coating layer 400 of the coil component 10D according to this exemplary embodiment may be extended to the third and fourth side surfaces 100C and 100D of the body, and may here also be extended to the other surface 102 opposing the one surface of the body. That is, the coating layer 400 may entirely cover the portion of the coil component except for the region where the external electrode 500 is formed, in contact with at least a portion of the external electrode 500, spaced apart from the external electrode 500, and is not limited thereto.

Descriptions of the other components are substantially the same as those described above, and detailed descriptions thereof are thus omitted.

### Manufacturing Method of Coil Component

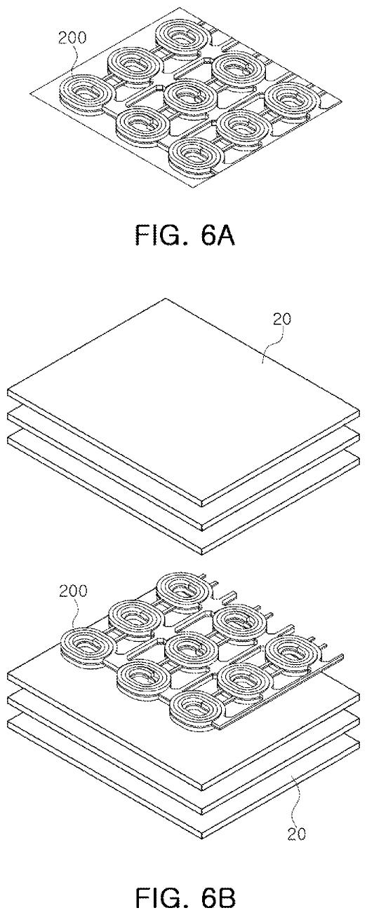

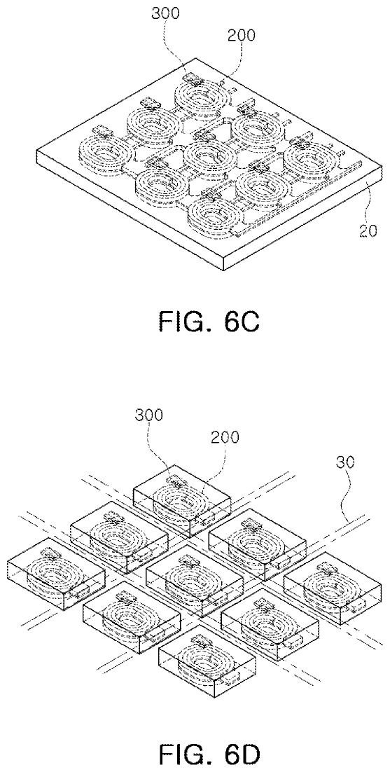

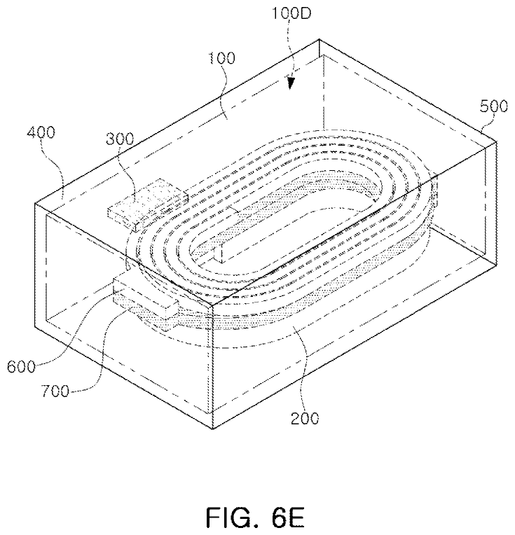

FIGS. 6A through 6E are views schematically illustrating a manufacturing method of a coil component according to the present disclosure.

As shown in FIG. 6A, first prepared is a coil bar which is formed by connecting a plurality of coils connected to each other and on which a magnetic sheet is stacked. Here shown is that the coil bar is disposed on a board, and the present disclosure is not limited thereto.

The following is a specific method of forming the coil bar.

A plurality of coil portions 200 may be formed on an insulation board. In this case, the coil portion 200 may include a coil pattern 210 and an insulating layer 220, as explained above. The insulation board may not be particularly limited, may be formed of at least one of a copper clad laminate, a prepreg (PPG), an Ajinomoto build-up film (ABF) and a photo imageable dielectric (PID) for example, and may have a thickness of 20 to 100 μm.

The coil pattern 210 may be formed by using, for example, an electroplating method, and is not limited thereto. The coil pattern 210 may be formed of a metal having excellent electrical conductivity, for example, silver (Ag), palladium (Pd), aluminum (Al), nickel (Ni), titanium (Ti), gold (Au), copper (Cu), platinum (Pt) or an alloy thereof.

A via may be formed by forming a via hole in a portion of the insulation board and then filling the via hole with a conductive material, and may electrically connect the coil patterns 210 respectively formed on one surface and the other surface of the insulation board to each other.

The coil pattern 210 may be connected to the lead-out portion 600 exposed to each of first and second side surfaces 100A and 100B of a body 100 after being diced. Respective both ends of adjacent coil pattern 210 in a state of the coil bar before being diced may be physically and electrically connected to each other.

A portion where the coil pattern 210 is not formed may then be removed from the insulation board.

The corresponding portion may be removed from the insulation board by using mechanical drilling, laser drilling, sand blasting, punching processing or the like, and may be removed by using a carbon dioxide (CO₂) laser drill for example.

A through hole passing through the insulation board may be formed by removing a central region of the insulation board, where the coil pattern 210 is not formed.

Here, it is possible not to remove a portion of the insulation board, where the coil pattern 210 is not formed, to form a connection portion.

Conventionally, all regions of the insulation board except for the region where the coil pattern 210 is formed are removed. However, in this exemplary embodiment of the present disclosure, it is possible not to remove one region of the board, where the coil pattern 210 is not formed, to form the connection portion, thereby increasing a force to support the coil pattern 210, which may minimize deformation of the coil pattern 210 when stacking and compressing the magnetic composite sheet.

An insulating layer 220 covering the coil pattern 210 may be formed on a surface of the coil pattern 210. The insulating layer 220 may be formed by using a method such as a screen printing method, a spray application process, a vacuum dipping process, a vapor deposition method (CVD) or a film lamination method, and is not limited thereto.

In addition, although not shown, the coil pattern 210 may be a wound coil covered by an insulating film and formed by a winding method. Here, the coil pattern 210 may be formed by forming a mold portion instead of the insulation board, and the insulation board may be removed after forming the wound coil pattern by using the insulation board, and is not limited thereto. Here, a method of forming the wound coil pattern may be the same as a known method.

Next, the body 100 may be formed by stacking a magnetic sheet 20 on the insulation board as shown in FIG. 6B.

The body 100 may be formed by stacking the magnetic sheet 20 on each of two sides of the insulation board and compressing the same by using a lamination method or a hydrostatic press method.

The magnetic sheet 20 may be formed by molding a magnetic material-resin composite in a sheet shape, and may be compressed in a semi-cured state. The magnetic material-resin composite may be a mixture of magnetic metal powder particles and a resin mixture. Here, the magnetic metal powder particles may mainly include iron (Fe), chromium (Cr) or silicon (Si), and the resin mixture may include epoxy, polyimide, liquid crystal polymer (LCP) or a mixture thereof, and are not limited thereto. An empty space in a space processed by the compression of the first magnetic sheet 20 may be filled with a magnetic material such as the magnetic material-resin composite. When a curing process is performed as a subsequent process, it is possible to prevent a coil 200 disposed at a predetermined position from being misaligned and to control deformation of the bar caused by movement of the sheet.

Here, a core portion may be formed when at least a portion of the magnetic sheet 20 fills the through hole formed in the central region of the insulation board.

Referring to FIG. 6C, at least one marker 300 may be disposed on one surface of the magnetic sheet 20 to correspond to an individual coil component in the coil bar on each of the upper and lower portion of which the magnetic sheet 20 is stacked.

Here, the marker 300 may include a material having a lower light transmittance than the coating layer 400, and may be visually identified. The marker 300 may indicate at least any one of the directionality, product name or manufacturing number of a coil component 10 according to the present disclosure, and is not limited thereto.

Referring to FIG. 6D, diced are the insulation board and the magnetic sheet stacked on each of the two sides thereof along a boundary between the plurality of processed spaces, i.e. dicing line 30. The dicing may be performed based on a size designed in advance, and as a result, the individual coil component 10 may be provided. The individual coil component 10 may be provided when the dicing is performed using a dicing equipment or another dicing method such as a blade or a laser.

Meanwhile, the individual coil component 10 may not include the insulation board and/or a fixing frame (not shown) after the dicing is performed when the insulation board and/or the fixing frame (not shown) is designed to be smaller than a region (i.e. dicing-kerf region) that is cut off by a width of the dicing blade or the like. That is, the insulation board and/or the fixing frame (not shown) are provided for stably seating the coil, and may thus remain or may not remain in the final coil component. However, in order to improve accuracy in fixedly positioning the coil portion 200, some portions of the insulation board and/or the fixing frame (not shown) may remain in the coil portion 200 when the insulation board is significantly close to the coil portion 200.

Although not shown in the drawings, a polishing process may be performed to polish corners of the individual coil component 10 after the dicing process. The body 100 of the coil component 10 may be made into a round shape by the polishing process, and conventionally, an insulating material may be additionally printed on a surface of the body 100 to prevent its plating. The insulating layer formed here may include at least one of a glass-based material including silicon (Si), an insulating resin and plasma.

On the other hand, in the coil component 10 according to the present disclosure, the marker 300 may be first disposed without printing the insulating material on the surface of the body 100. Next, as described below, the coating layer 400 may entirely cover six surfaces of the body 100 to cover the marker 300.

Referring to FIG. 6E, the coating layer 400 may cover each of the six surfaces of the body of the individual coil component 10.

Here, the coating layer 400 may include a light-transmitting resin, and may have a light transmittance of 85% or more and 95% or less with respect to a visible light wavelength. In addition, the coating layer 400 may have the light transmittance which may be visually identified from the visible light wavelength, and is not limited thereto. In more detail, the coating layer 400 may include an epoxy-based or silica-based resin, and is not limited thereto.

In particular, when the coating layer 400 has a light transmittance of less than 85% with respect to the visible light wavelength, it may be difficult to visually identify the marker 300 embedded in the coating layer 400, and when the coating layer 400 includes a material having a light transmittance of more than 95%, manufacturing costs may be excessively increased. Therefore, the coating layer 400 may have the light transmittance of 85% or more and 95% or less with respect to the visible light wavelength.

In this manner, it may be easy to read the mark by using the resin having a high light transmittance for the coating layer 400, and the coil component may thus be measured by using a current equipment specification as it is, or aligned or the like in a taping process by using the same. In addition, the coating layer 400 may have an increased degree of freedom in selecting its thickness by making a material of the coating layer 400 transparent or translucent, and is not limited thereto.

In addition, the coating layer 400 may cover each of the one surface 301 and both side surfaces 300A and 300B of the marker 300 to prevent the marker 300 from being damaged from an external physical impact.

Descriptions of the other components are substantially the same as those described above, and detailed descriptions thereof are thus omitted.

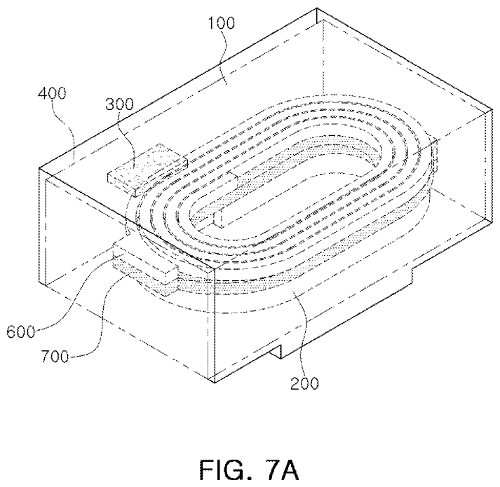

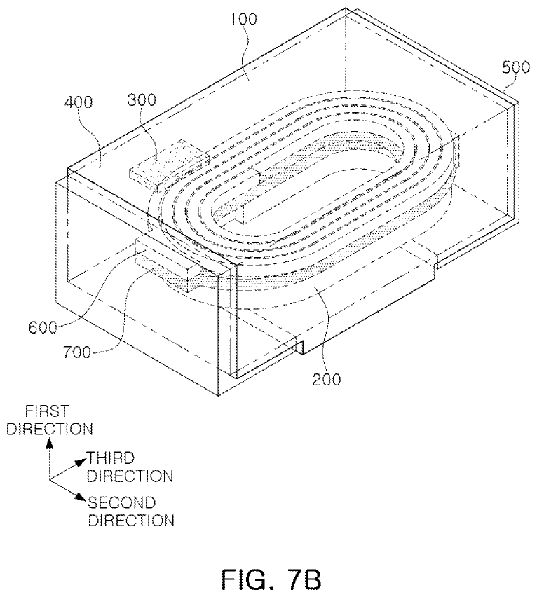

FIGS. 7A and 7B are views schematically illustrating the manufacturing method of a coil component according to the present disclosure.

Referring to the drawings, a dicing process may be performed to provide a plurality of individual coil portions 200, and an external electrode 500 may then be formed on a surface of an individual body 100.

Here, the external electrode 500 may be formed by peeling off a portion of a coating layer 400 disposed on the surface of the body 100, as shown in FIG. 7A. The coating layer 400 may be peeled off in consideration of a region where the external electrode 500 to be formed.

For example, the external electrode 500 disposed on each of one surface, the other surface, one side surface, and other side surfaces 101, 102, 100A and 100B of the body 100 may be formed by peeling off the coating layer 400 from each of at least a portion of each of the one surface 101 and the other surface 102 of the body and the one side surface and the other side surface 100A and 100B of the body. Alternatively, the external electrodes 500 may respectively be formed on the other surface 102 of the body to be spaced apart from each other by peeling off the coating layer 400 from only a portion of the other surface 102 opposing the one surface of the body 100. Alternatively, the external electrodes 500 may respectively be disposed on the other surface 102 of the body while being spaced apart from each other to respectively be extended to the one side surface and the other side surface 100A and 100B of the body by peeling off the coating layer 400 from the one side surface and the other side surface 100A and 100B of the body and from at least a portion of the other surface 102 of the body.

Next, the external electrode 500 may be formed in a region where the coating layer 400 is peeled off, as shown in FIG. 7B.

Although not shown, the external electrode 500 may have a monolayer or multilayer structure. For example, the external electrode may include a first layer including copper (Cu), a second layer disposed on the first layer and including nickel (Ni), and a third layer disposed on the second layer and including tin (Sn). Here, the first to third layers may each be formed by plating, and is not limited thereto. For another example, the external electrode 500 may include a resin electrode including conductive powder particles and a resin, and a plating layer formed on the resin electrode by plating.

The external electrode 500 may include copper (Cu), aluminum (Al), silver (Ag), tin (Sn), gold (Au), nickel (Ni), lead (Pd), titanium (Ti) or an alloy thereof, and is not limited thereto.

Descriptions of the other components are substantially the same as those described above, and detailed descriptions thereof are thus omitted.

In the present specification, an expression that a component is disposed on another component is not intended to set a direction. Accordingly, the expression that the component is disposed on another component may indicate that the component is disposed on an upper side of another component, or disposed on a lower side of another component.

In the present specification, terms such as an upper surface, a lower surface, an upper side, a lower side, an uppermost side, a lowermost side and the like indicate directions set based on the drawings for convenience of description. Therefore, depending on the set directions, the upper surface, the lower surface, the upper side, the lower side, the uppermost side, the lowest side and the like may be described with different terms.

A meaning that a component is connected to another component herein conceptually includes not only a direct connection between two components but also their indirect connection through a third component. In addition, a term “electrically connected” conceptually includes a physical connection and a physical disconnection.

In the present specification, terms such as “first” and “second” are used to distinguish one component from another component, and do not limit a sequence, importance and the like of the corresponding components. In some cases, a first component may be named a second component and a second component may also be similarly named a first component, without departing from the scope of the present disclosure.

As set forth above, according to the exemplary embodiments of the present disclosure, it is possible to provide the coil component which may be mounted on the board including the microcircuit pattern.

According to the exemplary embodiments of the present disclosure, it is also possible to provide the coil component which may prevent the damage to the mark.

The term “an exemplary embodiment” used herein does not refer to the same exemplary embodiment, and is provided to emphasize a particular feature different from that of another exemplary embodiment. However, the exemplary embodiments provided herein may be implemented by being combined in whole or in part one with one another. For example, one element described in a particular exemplary embodiment may be understood as a description related to another exemplary embodiment even if it is not described in another exemplary embodiment, unless an opposite or contradictory description is provided therein.

Terms used herein are used only in order to describe an exemplary embodiment rather than limiting the present disclosure. In this case, singular forms include plural forms unless interpreted otherwise in context.

While exemplary embodiments have been shown and described above, it will be apparent to those skilled in the art that modifications and variations could be made without departing from the scope of the present disclosure as defined by the appended claims.

What is claimed is:

1. A coil component comprising:
a body including a first surface, and a first side surface and a second side surface respectively connected to the first surface and opposing each other;
a coil portion disposed within the body;
a marker disposed on the first surface of the body; and
a coating layer disposed on the first surface of the body to cover the marker,
wherein the coating layer includes a light-transmitting resin.

2. The coil component of claim 1, wherein the coating layer has a light transmittance in a range from 85% to 95% with respect to a visible light wavelength.

3. The coil component of claim 1, wherein each of the marker and the coating layer has at least a portion in contact with the first surface of the body.

4. The coil component of claim 1, wherein the marker protrudes from the body, and a first surface of the marker and both side surfaces of the marker connected to the first surface, are each in contact with the coating layer.

5. The coil component of claim 1, further comprising:
a lead-out portion connected to the coil portion and having at least a portion exposed to each of the first side surface and the second side surface of the body; and
external electrodes respectively disposed on a second surface of the body opposing the first surface, while being spaced apart from each other.

6. The coil component of claim 5, wherein the lead-out portion includes a connection portion connected to the external electrode.

7. The coil component of claim 5, wherein the external electrode is extended to at least a portion of each of the first side surface and the second side surface of the body, and connected to the lead-out portion.

8. The coil component of claim 7, wherein the coating layer has a light transmittance in a range from 85% to 95% with respect to a visible light wavelength.

9. The coil component of claim 7, wherein each of the marker and the coating layer has at least a portion in contact with the first surface of the body.

10. The coil component of claim 7, wherein the marker protrudes from the body, and a first surface of the marker and both side surfaces of the marker connected to the first surface, are each in contact with the coating layer.

11. The coil component of claim 7, wherein the external electrode is spaced apart from the coating layer.

12. The coil component of claim 7, wherein the external electrode has at least a portion extended to the first surface of the body.

13. The coil component of claim 12, wherein the coating layer covers at least a portion of each of the first surface and the second surface of the body, and four side surfaces of the body, respectively connected to the first surface and the second surface.

14. The coil component of claim 1, further comprising a board having a first surface on which the coil portion is disposed, and having at least a portion exposed to each of the first side surface and the second side surface of the body.

15. The coil component of claim 14, wherein the coating layer has a light transmittance in a range from 85% to 95% with respect to a visible light wavelength.

16. The coil component of claim 1, wherein each of the marker and the coating layer has at least a portion in contact with the first surface of the body,
the marker protrudes from the body, and a first surface of the marker and both side surfaces of the marker connected to the first surface, are each in contact with the coating layer; and
the coating layer covers at least a portion of each of the first surface and a second surface of the body, and four side surfaces of the body, respectively connected to the first surface and the second surface.

17. The coil component of claim 1, wherein the coil portion is a wound-type coil, and
the coating layer has a light transmittance in a range from 85% to 95% with respect to a visible light wavelength.

18. The coil component of claim 17, wherein the marker protrudes from the body, and first surface of the marker and both side surfaces of the marker connected to the first surface, are each in contact with the coating layer.

19. A manufacturing method of a coil component, the method comprising:
preparing a coil bar on which a magnetic sheet is stacked;
disposing a marker to have at least a portion in contact with a first surface of the magnetic sheet;
preparing a body having first to sixth surfaces by routing the coil bar on which the marker is disposed; and
disposing a coating layer covering the marker and covering the first to sixth surfaces of the body, the coating layer including a light-transmitting resin.

20. The method of claim 19, wherein the coating layer has a light transmittance in an range from 85% to 95% for a visible light wavelength.

21. The method of claim 19, further comprising:
peeling off at least a portion of the coating layer; and
disposing an external electrode in a region where the coating layer is peeled off.

22. A coil component comprising:
a body including a first surface, a second surface opposing the first surface and four side surfaces connecting the first and second surfaces;
a coil portion disposed within the body;
a marker disposed on the first surface of the body, the marker having a first marker surface contacting the first surface of the body, a second marker surface opposing the the first surface and disposed away from the body, and four marker side surfaces connecting the first and second marker surfaces; and
a transparent coating layer disposed on at least a portion of each of the first surface and the second surface of the body, the coating layer covering the second marker surface and the four marker side surfaces.

23. The coil component of claim 22, wherein the transparent coating layer has a light transmittance in a range from 85% to 95% for a wavelength in visible range.

24. The coil component of claim 22, further comprising external electrodes connected to opposite ends of the coil portion and contacting at least one surface of the body.

25. The coil component of claim 22, wherein the transparent coating layer is further disposed on at least a portion of each of the four side surfaces of the body.
